(19) United States
(12) Patent Application Publication
(10) Pub. No.: US 2014/0181563 A1
(43) Pub. Date: Jun. 26, 2014

(54) SYSTEM AND METHOD FOR DETERMINATION OF LATENCY TOLERANCE

(71) Applicants: Neil Songer, Santa Clara, CA (US); Barnes Cooper, Tigard, OR (US); Robert Gough, Sherwood, OR (US); Jaya Jeyaseelan, Cupertino, CA (US); William Knolla, Folsom, CA (US)

(72) Inventors: Neil Songer, Santa Clara, CA (US); Barnes Cooper, Tigard, OR (US); Robert Gough, Sherwood, OR (US); Jaya Jeyaseelan, Cupertino, CA (US); William Knolla, Folsom, CA (US)

(21) Appl. No.: 13/726,485

(22) Filed: Dec. 24, 2012

(51) Int. Cl. G06F 1/28

(52) U.S. Cl. CPC G06F 1/28
USPC 713/340

(57) ABSTRACT

Particular embodiments described herein can offer a method that includes determining that a first reported latency tolerance associated with at least one first device has not been received, and causing determination of a platform latency tolerance based, at least in part, on a first predefined latency tolerance, which is to serve as a substitute for the first reported latency tolerance.

### TECHNICAL HELD

Embodiments described herein generally relate to determining a latency tolerance in a processor environment.

### BACKGROUND

As electronic apparatuses become more complex and ubiquitous in the everyday lives of users, more and more diverse requirements are placed upon them. For example, many electronic apparatuses can operate on battery power, thus allowing users to operate these devices in many different circumstances. In addition, as capabilities of electronic apparatuses become more extensive, many users have become reliant on the enhanced performance such capabilities provide. As these aspects of electronic apparatuses have evolved, there has become an increasing need for reducing power consumption. However, under many circumstances, reducing power consumption may sacrifice performance. Therefore, it will be highly beneficial for a user to be able to have the desired performance when it matters the most to them, and optimizing power performance during circumstances where performance may be less important to them. One possible area that may be advantageous for such improvements may pertain to the communication of latency concerns regarding devices of an electronic apparatus.

### BRIEF DESCRIPTION OF THE DRAWINGS

Embodiments are illustrated by way of example and not by way of limitation in the FIGURES of the accompanying drawings, in which like references indicate similar elements and in which:

FIG. 1 is a block diagram illustrating components associated with determining latency tolerance according to at least one example embodiment;

FIG. 2 is another block diagram illustrating components associated with determining latency tolerance according to at least one example embodiment;

FIG. 3 is yet another block diagram illustrating components associated with determining latency tolerance according to at least one example embodiment;

FIG. 4 is a flow diagram showing a set of operations for determining latency tolerance according to at least one example embodiment;

FIGS. 5A-5B are flow diagrams showing sets of operations for determining latency tolerance according to at least one example embodiment;

FIG. 6 is yet another flow diagram showing a set of operations for determining latency tolerance according to at least one example embodiment;

FIG. 7 is still another flow diagram showing a set of operations for determining latency tolerance according to at least one example embodiment;

FIG. 8 is yet still another flow diagram showing a set of operations for determining latency tolerance according to at least one example embodiment;

FIG. 9 is a simplified block diagram associated with an example ARM ecosystem system on chip (SOC) of the present disclosure; and

FIG. 10 is a simplified block diagram illustrating example logic that may be used to execute activities associated with the present disclosure.

The FIGURES of the drawings are not necessarily drawn to scale or proportion, as their dimensions, arrangements, and specifications can be varied considerably without departing from the scope of the present disclosure.

### DETAILED DESCRIPTION OF EXAMPLE EMBODIMENTS

The following detailed description sets forth example embodiments of apparatuses, methods, and systems relating to providing a power savings in a processor environment. Features such as structure(s), function(s), and/or characteristic(s), for example, are described with reference to one embodiment as a matter of convenience; various embodiments may be implemented with any suitable one or more of the described features. It should be understood that terms such as “first”, “second”, etc. are merely used for differentiation purposes, and do not denote any sequential relationship, chronological relationship, and/or the like.

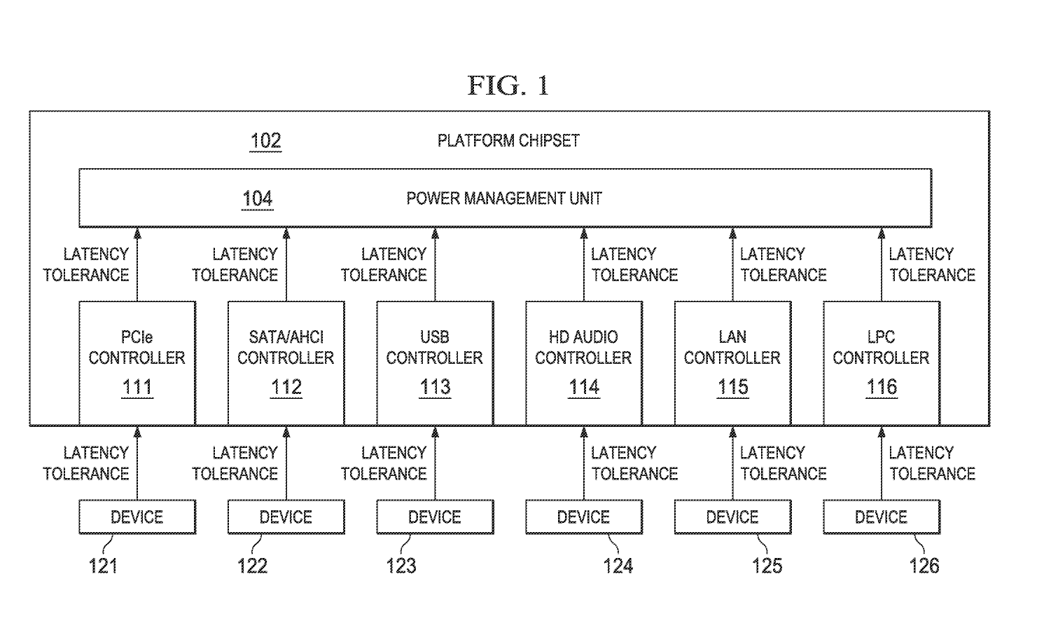

FIG. 1 is a block diagram illustrating components associated with determining latency tolerance according to at least one example embodiment. The examples of FIG. 1 are merely examples of components associated with determining latency tolerance, and do not limit the scope of the claims. For example, operations attributed to a component may vary, number of components may vary, composition of a component may vary, and/or the like. For example, in some example embodiments, operations attributable to one component of the example of FIG. 1 may be allocated to one or more other components.

In electronic devices, there is often a tradeoff between power saving and performance. For example, lesser power saving states may have longer associated latency times than higher power saving states. In some circumstances, it may be desirable to avoid performance degradation associated with power saving. For example, if a device performs an operation that would benefit from the use of another device within a certain period of time, it may be desirable to influence power saving measures such that the power saving still allows the device to use the other device without undue delay. For example, a hard drive may benefit from avoiding circumstances where a processor is unable to receive information associated with a read operation due to a power saving recovery. The amount of time in which a power saving feature should avoid interference with a device may be referred to as a latency tolerance. For example, if a device benefits from avoiding unavailability of another device after a specified period of time, the latency tolerance for the device may indicate a value of the specified period of time. Under some circumstances, devices may communicate their latency tolerances, but in other circumstances, devices may be unable to communicate their latency tolerances in a timely manner. In still other circumstances, devices may be unable to communicate their latency tolerances altogether.

The example of FIG. 1 illustrates devices 121-126 in communication with platform chipset 102. Platform chipset 102 may comprise a platform power management unit 104. Power management unit 104 may be in communication with controllers 111-116. Even though the controllers of the example of FIG. 1 includes enhanced peripheral control interface (PCIe) controller 111, serial advanced technology attachment/advanced host controller interface (SATA/AHCI) controller 112, universal serial bus (USB) controller 113, hi definition (HD) audio controller 114, local area network (LAN) controller 115, and low pin count (LPC) controller 116, the controllers comprised by platform chipset 102 may vary.

In at least one example embodiment, a device, such as device 121, sends information indicating a latency tolerance to a controller, such as PCIe controller 111. In such embodiments, a controller, such as PCIe controller 111, may receive information indicating the latency tolerance. In at least one embodiment, a controller, such as USB controller 113, sends information indicating a latency tolerance to power management unit 104. In such embodiments, power management unit 104 may receive information indicating the latency tolerance.

Latency tolerance information received from another component may be referred to as a reported latency tolerance. A reported latency tolerance may be received from a component so that a device, a set of devices, a controller, a set of controllers, a platform, a set of platforms, and/or the like, may inform another component of latency tolerance associated with other components with which the component communicates. In the example of FIG. 1, device 121 sends a latency tolerance to PCIe controller 111. From the perspective of the PCIe controller, the latency tolerance sent by device 121 is a reported latency tolerance. In such an example, PCIe controller 111 sends a latency tolerance to power management unit 104. From the perspective of power management unit 104, the latency tolerance sent by PCIe controller 111 is a reported latency tolerance.

In at least one example embodiment, a controller, such as LPC controller 116, is in communication with one or more devices, such as device 126. In such an embodiment, the controller may receive reported latency tolerance from each device with which the controller is in communication. In other words, the reported latency tolerance may represent at least one device. The controller may determine a latency tolerance based on the reported latency tolerance of the devices with which the controller is connected. For example, the controller may determine the latency tolerance to be the lowest value indicated by the reported latency tolerances. The controller may perform determination of the latency tolerance in response to receiving the reported latency tolerance. In other words, the device may cause the controller to determine the latency tolerance associated with the one or more devices by sending the latency tolerance to the controller. For example, if LAN controller 115 is in communication with device 125 and other devices, device 125 may cause LAN controller 115 to determine latency tolerance for device 125 and the other devices by sending a latency tolerance to LAN controller 115.

In at least one example embodiment, power management unit 104 receives reported latency tolerance from each controller with which the controller, such as USB controller 114, is in communication. For at least the reason that each controller may be in communication with one or more devices, the reported latency tolerance from a controller may represent one or more devices. Power management unit 104 may determine a latency tolerance based on the reported latency tolerance of the controllers with which power management unit 104 is in communication. The latency tolerance determined by power management unit 104 may be referred to as the platform latency tolerance. The platform latency tolerance represents a latency tolerance associated with the collection of devices in communication with the controllers with which power management unit 104 is in communication. For example, power management unit 104 may determine the platform latency tolerance to be the lowest value indicated by the reported latency tolerances of the controllers. Power management unit 104 may perform determination of the platform latency tolerance in response to receiving the reported latency tolerance. In other words, a controller, such as SATA/AHCI controller 112, may cause power management unit 104 to determine the platform latency tolerance associated with the one or more devices by sending the latency tolerance to power management unit 104. For example, USB controller 113 may cause power management unit 104 to determine the platform latency tolerance by sending a latency tolerance to power management unit 104.

A device in communication with a controller may be referred to as being attached to the controller. For example, in FIG. 1, device 126 may be attached to LPC controller 116. A controller may determine that a device is attached. For example, there may be a signal, a message, an indicator, and/or the like that indicates to the controller that a device is attached. In circumstances where more than one device is attached to a controller, the controller may determine that each device is attached to the controller.

There may be circumstances where at least one device does not send a latency tolerance to a controller. For example, the device may not support communication of a latency tolerance, a protocol used for communication between the device and the controller may not support communication of latency tolerance, the controller may not support communication of latency tolerance, and/or the like. In another example, even though the device may be capable of sending a latency tolerance, the sending may be delayed. Therefore, in such circumstances, there may be no reported latency tolerance associated with a device, at the controller and/or at the power management unit 104. It may be desirable to associate a latency tolerance with such a device in the absence of a reported latency tolerance.

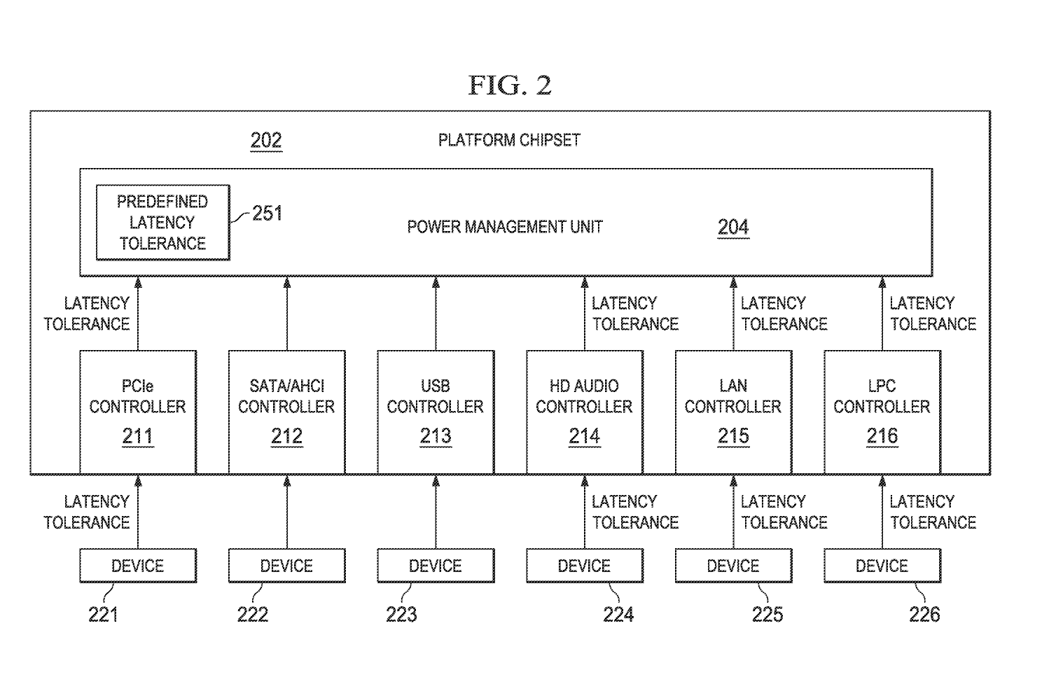

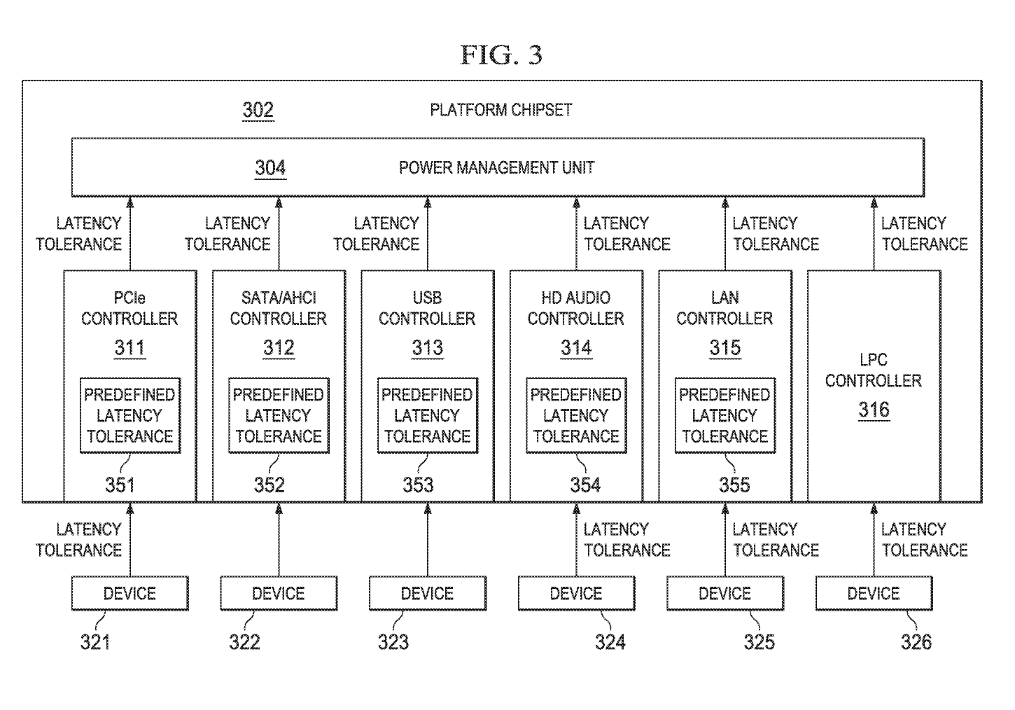

Under such circumstances, a predefined latency tolerance may be used. The predefined latency tolerance may indicate a value that may serve as a substitute for a reported latency tolerance. The predefined latency tolerance may be a value associated with one or more devices for which no reported latency tolerance was received. There may be one or more predefined latency tolerances. The value of a predefined latency tolerance may be static or dynamic. For example, a predefined latency tolerance may be set prior to operation of a platform chipset, for example platform chipset 202 (of FIG. 2). In some circumstances, a device may delay sending a latency tolerance. Under such circumstances, it may be desirable to utilize a predetermined latency tolerance until the device sends a latency tolerance. In other words, it may be desirable to utilize a predetermined latency tolerance until a reported latency tolerance is received. In another example, a predefined latency tolerance may be modified during operation of a platform chipset, for example platform chipset 302 (of FIG. 3). In such an example, a component, such as a driver, may send a directive indicating a value to which the predefined latency tolerance should be set.

Without limiting the scope of the claims in any way, at least one technical advantage to providing a predetermined latency tolerance may be allowing the power management unit to consider latency tolerance implications associated with devices that do not provide a latency tolerance, and/or allowing the power management unit to determine platform latency tolerance without waiting for a reported latency tolerance from each controller, or for each device.

FIG. 2 is another block diagram illustrating components associated with determining latency tolerance according to at least one example embodiment. The examples of FIG. 2 are merely examples of components associated with determining latency tolerance, and do not limit the scope of the claims. For example, operations attributed to a component may vary, number of components may vary, composition of a component may vary, and/or the like. For example, in some example embodiments, operations attributable to one component of the example of FIG. 2 may be allocated to one or more other components.

The example of FIG. 2 relates to devices 221-226 in communication with platform chipset 202. Platform chipset 202 may comprise a platform power management unit 204. Power management unit 204 may be in communication with controllers 211-216. Even though the controllers of the example of FIG. 2 are PCIe controller 211, SATA/AHCI controller 212, USB controller 213, HD audio controller 214, LAN controller 215, and LPC controller 216, the controllers comprised by platform chipset 202 may vary.

In the example of FIG. 2, device 221 sends a latency tolerance to PCIe controller 211, device 224 sends a latency tolerance to HD audio controller 214, device 225 sends a latency tolerance to LAN controller 215, and device 226 sends a latency tolerance to LPC controller 216. In the example of FIG. 2, PCIe controller 211 receives a reported latency tolerance from device 221 and sends a latency tolerance to power management unit 204. In the example of FIG. 2, HD audio controller 214 receives a reported latency tolerance from device 224 and sends a latency tolerance to power management unit 204. In the example of FIG. 2, LAN controller 215 receives a reported latency tolerance from device 225 and sends a latency tolerance to power management unit 204. In the example of FIG. 2, LPC controller 216 receives a reported latency tolerance from device 226 and sends a latency tolerance to power management unit 204. In the example of FIG. 2, power management unit 204 receives a reported latency tolerance from PCIe controller 211, HD audio controller 214, LAN controller 215, and LPC controller 216.

In the example of FIG. 2, device 222 does not send a latency tolerance to SATA/AHCI controller 212, and device 223 does not send a latency tolerance to USB controller 213. In the example of FIG. 2, SATA/AHCI controller 212 does not receive a reported latency tolerance from device 222 and does not send a latency tolerance to power management unit 204. In the example of FIG. 2, USB controller 213 does not receive a reported latency tolerance from device 223 and does not send a latency tolerance to power management unit 204.

In the example of FIG. 2, power management unit 204 comprises predefined latency tolerance 251. In circumstances where power management unit 204 has not received a reported latency tolerance associated with an attached device, power management unit 204 may determine a platform latency tolerance based, at least in part, on predefined latency tolerance 251. The determination may be based, at least in part, on predefined latency tolerance 251 serving as a substitute for a reported latency tolerance associated with the attached device. For example, when determining the platform latency tolerance, power management unit 204 may evaluate predefined latency tolerance 251 as if power management unit 204 had received a reported latency tolerance associated with the device for which no reported latency tolerance was received. For example, power management unit 204 may determine platform latency tolerance based, at least in part, on reported latency tolerance from PCIe controller 211, reported latency tolerance from HO audio controller 214, reported latency tolerance from LAN controller 215, reported latency tolerance from LPC controller 216, and predefined latency tolerance 251. Power management unit 204 may substitute predefined latency tolerance 251 for the reported latency tolerances that were not received from STAT/AHCI controller 212 and USB controller 213.

In at least one example embodiment, power management unit 204 may receive a directive to change the value indicated by predefined latency tolerance to a different value. The directive may be a message, an indicator, a signal, and/or the like. For example, a device driver may send the directive. In response to receiving the directive, power management unit 204 may determine the platform latency tolerance based, at least in part, on the predetermined latency tolerance indicating the different value. In at least one example embodiment, power management unit 204 may change the value stored in association with predefined latency tolerance 251 in response to receiving the directive.

FIG. 3 is yet another block diagram illustrating components associated with determining latency tolerance according to at least one example embodiment. The examples of FIG. 3 are merely examples of components associated with determining latency tolerance, and do not limit the scope of the claims. For example, operations attributed to a component may vary, number of components may vary, composition of a component may vary, and/or the like. For example, in some example embodiments, operations attributable to one component of the example of FIG. 3 may be allocated to one or more other components.

The example of FIG. 3 relates to devices 321-326 in communication with platform chipset 302. Platform chipset 302 may comprise a platform power management unit 304. Power management unit 304 may be in communication with controllers 311-316. Even though the controllers of the example of FIG. 3 are PCIe controller 311, SATA/AHCI controller 312, USB controller 313, HD audio controller 314, LAN controller 315, and LPC controller 316, the controllers comprised by platform chipset 302 may vary.

In the example of FIG. 3, device 321 sends a latency tolerance to PCIe controller 311, device 324 sends a latency tolerance to HD audio controller 314, device 325 sends a latency tolerance to LAN controller 315, and device 326 sends a latency tolerance to LPC controller 316. In the example of FIG. 3, PCIe controller 311 receives a reported latency tolerance from device 321 and sends a latency tolerance to power management unit 304. In the example of FIG. 3, HD audio controller 314 receives a reported latency tolerance from device 324 and sends a latency tolerance to power management unit 304. In the example of FIG. 3, LAN controller 315 receives a reported latency tolerance from device 325 and sends a latency tolerance to power management unit 304. In the example of FIG. 3, LPC controller 316 receives a reported latency tolerance from device 326 and sends a latency tolerance to power management unit 304. In the example of FIG. 3, power management unit 304 receives a reported latency tolerance from PCIe controller 311, SATA/AHCI controller 312, USB controller 313, audio controller 214, LAN controller 215, and LPC controller 216.

In the example of FIG. 3, device 322 does not send a latency tolerance to SATA/AHCI controller 312, and device 323 does not send a latency tolerance to USB controller 313. In the example of FIG. 3, SATA/AHCI controller 312 does not receive a reported latency tolerance from device 322, but sends a latency tolerance to power management unit 304. In the example of FIG. 3, USB controller 313 does not receive a reported latency tolerance from device 323, but sends a latency tolerance to power management unit 304.

In the example of FIG. 3, controllers comprise a predefined latency tolerance. PCIe controller 311 comprised predefined latency tolerance 351, SATA/AHCI controller 312 comprises predefined latency tolerance 352, USB controller 313 comprises predefined latency tolerance 353, HD audio controller 314 comprises predefined latency tolerance 334, and LAN controller 315 comprises predefined latency tolerance 355. It should be noted that all controllers may comprise a predefined latency tolerance or less than all controllers may comprise a predefined latency tolerance. In the example of FIG. 3, LPC controller 316 does not comprise a predefined latency tolerance.

In circumstances where a controller, such as USB controller 313, has not received a reported latency tolerance associated with an attached device, the controller may determine a latency tolerance based, at least in part, on a predefined latency tolerance, such as predefined latency tolerance 353. The determination may be based, at least in part, on the predefined latency tolerance serving as a substitute for a reported latency tolerance associated with an attached device. For example, when determining the latency tolerance, the controller may evaluate a predefined latency tolerance as if the controller had received a reported latency tolerance associated with the device for which no reported latency tolerance was received. For example, the controller may determine a latency tolerance based, at least in part, on a reported latency tolerance from a first device, a reported latency tolerance from a second device, and a predefined latency tolerance. The controller may substitute a predefined latency tolerance for the reported latency tolerances that were not received from one or more devices. Upon determining the latency tolerance, the controller may send the determined latency tolerance to power management unit 304. In at least one example embodiment, a controller may cause determination of a platform latency tolerance based on its predefined latency tolerance by sending its determined latency tolerance to power management unit 304. The sending, by the controller, of the latency tolerance that was based, at least in part, on the predetermined latency tolerance causes determination of the platform latency tolerance to also be based, at least in part on the predefined latency tolerance. In at least one example embodiment, the controller sends the predefined latency tolerance in place of a reported latency tolerance that was not received.

In at least one example embodiment, a controller, such as SATA/AHCI controller 312, may receive a directive to change the value indicated by a predefined latency tolerance, such as predefined latency tolerance 352, to a different value. The directive may be a message, an indicator, a signal, and/or the like. For example, a device driver may send the directive. In response to receiving the directive, a controller may determine a latency tolerance based, at least in part, on the predetermined latency tolerance indicating the different value. In at least one example embodiment, a controller may change the value stored in association with its predefined latency tolerance in response to receiving the directive.

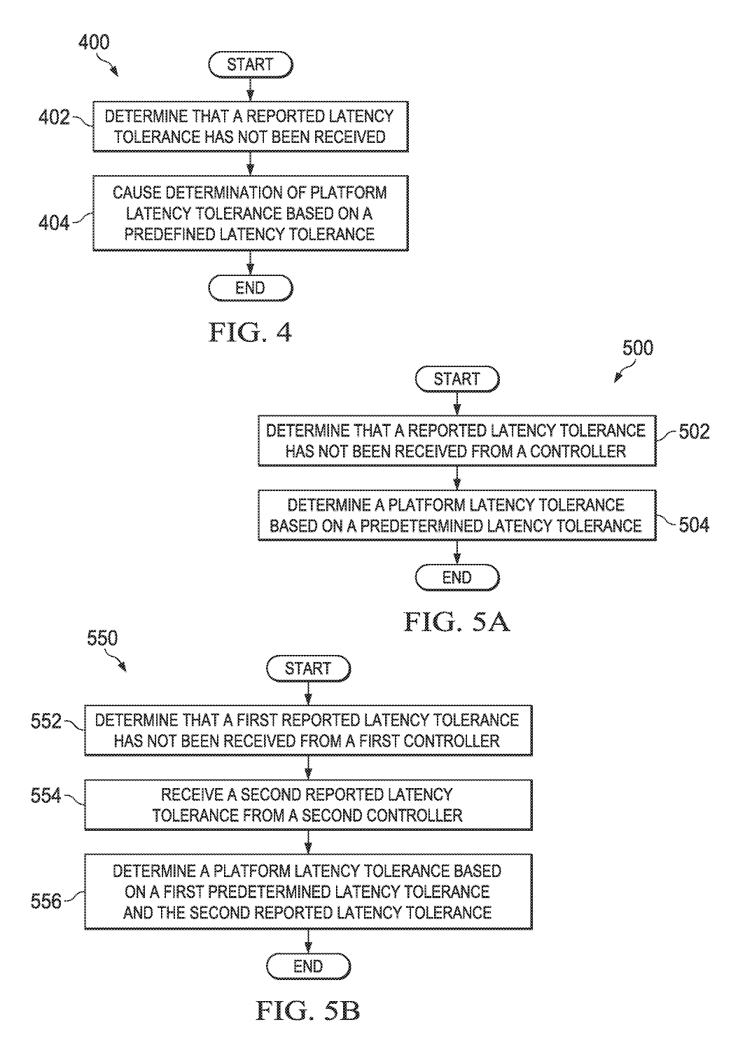

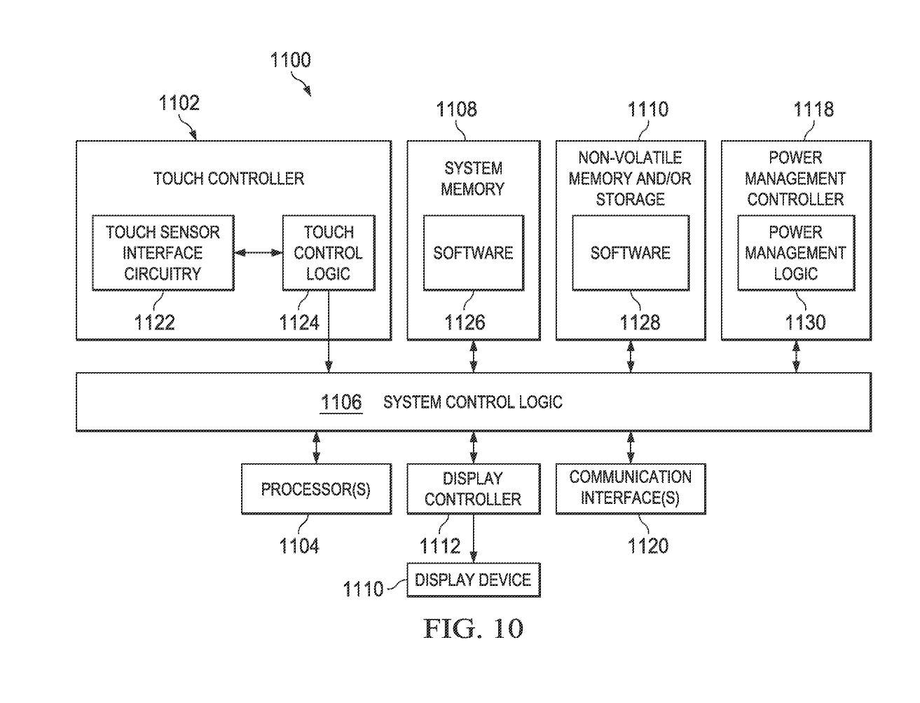

FIG. 4 is a flow diagram showing a set of operations 400 for determining latency tolerance according to at least one example embodiment. An apparatus, for example system 1100 of FIG. 10 or a portion thereof, may utilize the set of operations 400. The apparatus may comprise means, including, for example processor 1104 of FIG. 10, for performing the operations of FIG. 4. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 400. In at least one example embodiment, set of operations 400 may be performed by a power management unit, by a controller, and/or the like.

At block 402, the apparatus determines that a reported latency tolerance has not been received. This determination may comprise determining that a device is attached and that no reported latency associated with the attached device has been received. Determination that the reported latency tolerance has not been received may comprise determining that there has been no reported latency tolerance after a device was attached. In at least one example embodiment, determination that a reported latency tolerance has not been received may occur when a device is attached, upon elapse of a predetermined amount of time after a device attaches, and or the like. In at least one example embodiment, determining that a reported latency tolerance was not received may comprise determining that a controller did not send the reported latency tolerance, similar as described regarding FIG. 2. In at least one example embodiment, determining that a reported latency tolerance was not received may comprise determining that a device did not send the reported latency tolerance, similar as described regarding FIG. 3. The reported latency tolerance may be similar as described regarding FIGS. 1-3.

At block 404, the apparatus causes determination of a platform latency tolerance based on a predefined latency tolerance. The platform latency tolerance and predefined latency tolerance may be similar as described regarding FIGS. 1-3. In at least one example embodiment, causing of determination of the platform latency tolerance may comprise determining the platform latency tolerance, similar as described with reference to FIG. 2. For example, causing determination of platform latency may comprise performing a set of operations that select the lowest latency tolerance of a set of one or more reported latency tolerances and/or one or more predefined latency tolerances. In at least one example embodiment, causing determination of platform latency tolerance comprises sending a latency tolerance to a power management unit, similar as described regarding FIG. 3.

FIG. 5A is a flow diagram showing a set of operations 500 for determining latency tolerance according to at least one example embodiment. An apparatus, for example system 1100 of FIG. 10 or a portion thereof, may utilize the set of operations 500. The apparatus may comprise means, including, for example processor 1104 of FIG. 10, for performing the operations of FIG. 5A. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 500. In at least one example embodiment, set of operations 500 may be performed by a power management unit.

At block 502, the apparatus determines that a reported latency tolerance has not been received form a controller. The determination that the reported latency tolerance has not been received form a controller may be similar as described regarding block 402 of FIG. 4. At block 504, the apparatus determines the platform latency tolerance based on a predetermined latency tolerance. The determination of the platform latency tolerance based on the predetermined latency tolerance may be similar as described regarding block 404 of FIG. 4.

FIG. 5B is a flow diagram showing a set of operations 550 for determining latency tolerance according to at least one example embodiment. An apparatus, for example system 1100 of FIG. 10 or a portion thereof, may utilize the set of operations 550. The apparatus may comprise means, including, for example processor 1104 of FIG. 10, for performing the operations of FIG. 5B. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 550. In at least one example embodiment, set of operations 550 may be performed by a power management unit.

At block 552, the apparatus determines that a first reported latency tolerance has not been received from a first controller. The determination that the first reported latency tolerance has not been received from the first controller may be similar as described regarding block 502 of FIG. 5A. At block 554, the apparatus receives a second reported latency from a second controller. In at least one example embodiment, the second controller is a different controller than the first controller. At block 556, the apparatus determines platform latency tolerance based on a first predetermined latency tolerance and the second reported latency tolerance. The determination of platform latency tolerance may be similar as described regarding block 504 of FIG. 58, where the determination of platform latency tolerance is further based, at least in part, on the second reported latency, similar as described regarding FIG. 2.

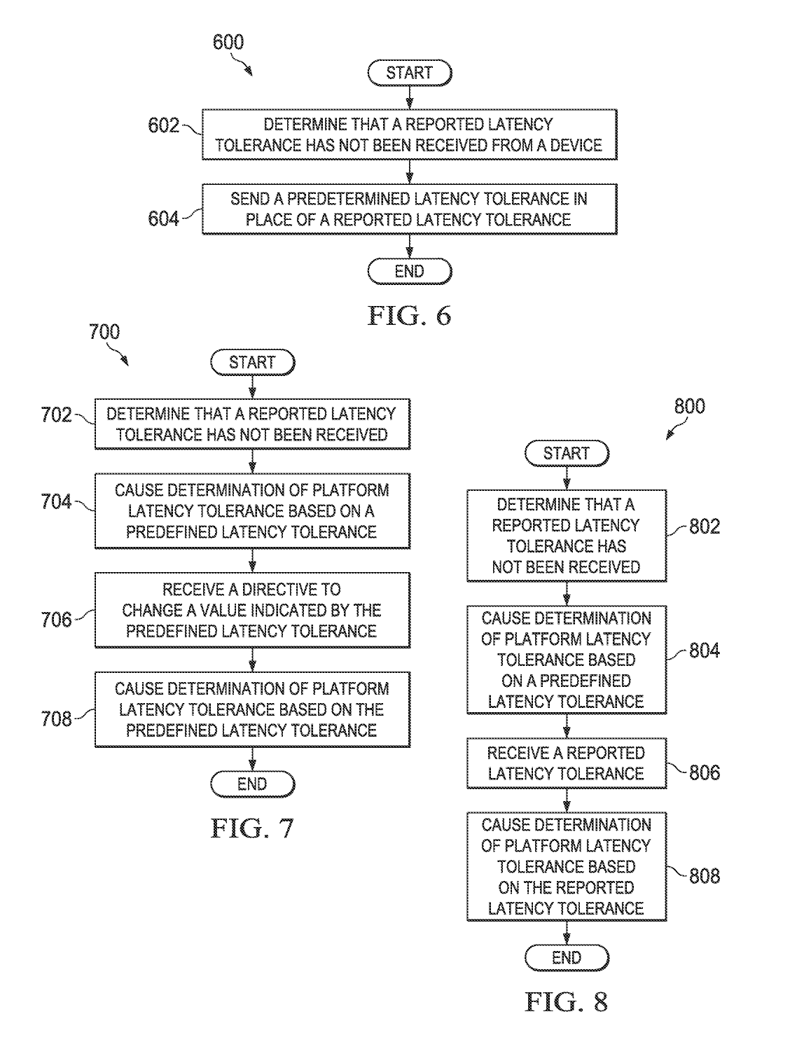

FIG. 6 is a flow diagram showing a set of operations 600 for determining latency tolerance according to at least one example embodiment. An apparatus, for example system 1100 of FIG. 10 or a portion thereof, may utilize the set of operations 600. The apparatus may comprise means, including, for example processor 1104 of FIG. 10, for performing the operations of FIG. 6. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 600. In at least one example embodiment, set of operations 600 may be performed by a controller.

At block 602, the apparatus determines that a reported latency tolerance has not been received from a device. The determination that the reported latency tolerance has not been received from the device may be similar as described regarding block 402 of FIG. 4. At block 604, the apparatus sends a latency tolerance based on a predetermined latency tolerance in place of a reported latency tolerance. In at least one example embodiment, the apparatus further performs determining the latency tolerance based at least in part on the predetermined latency tolerance, similar as described regarding FIG. 3. The sending of the latency tolerance may be performed in response to performance of such determination. In at least one example embodiment, the apparatus sends the predefined latency tolerance in place of the reported latency tolerance. In at least one example embodiment, the sending may be similar as described regarding block 404 of FIG. 4.

FIG. 7 is a flow diagram showing a set of operations 700 for determining latency tolerance according to at least one example embodiment. An apparatus, for example system 1100 of FIG. 10 or a portion thereof, may utilize the set of operations 700. The apparatus may comprise means, including, for example processor 1104 of FIG. 10, for performing the operations of FIG. 7. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 700. In at least one example embodiment, set of operations 700 may be performed by a power management unit, a controller, and/or the like.

At block 702, the apparatus determines that a reported latency tolerance has not been received, similar as described regarding block 402 of FIG. 4. At block 704, the apparatus causes determination of platform latency tolerance based, at least in part, on a predefined latency tolerance, similar as described regarding block 404 of FIG. 4. At block 706, the apparatus receives a directive to change a value indicated by the first predefined latency to a different value. The directive and change in value may be similar as described regarding FIG. 1. The apparatus may further cause storing of the different value in association with the predefined latency tolerance. At block 708, the apparatus causes determination of the platform latency tolerance based, at least in part, on the predefined latency tolerance indicating the different value. The causing of determination of the platform latency may be performed in response to receiving the directive, storing the different value of the directive, and/or the like.

FIG. 8 is a flow diagram showing a set of operations 800 for determining latency tolerance according to at least one example embodiment. An apparatus, for example system 1100 of FIG. 10 or a portion thereof, may utilize the set of operations 800. The apparatus may comprise means, including, for example processor 1104 of FIG. 10, for performing the operations of FIG. 8. In an example embodiment, an apparatus, for example system 1100 of FIG. 10, is transformed by having memory, for example system memory 1108 of FIG. 10, comprising computer code configured to, working with a processor, for example processor 1104 of FIG. 10, cause the apparatus to perform set of operations 800. In at least one example embodiment, set of operations 800 may be performed by a power management unit, a controller, and/or the like.

At block 802, the apparatus determines that a reported latency tolerance has not been received, similar as described regarding block 402 of FIG. 4. At block 804, the apparatus causes determination of platform latency tolerance based, at least in part, on a predefined latency tolerance, similar as described regarding block 404 of FIG. 4. At block 806, the apparatus receives a reported latency tolerance similar as described regarding FIG. 1. The receiving of the reported latency tolerance may occur after the causing of determination of platform latency tolerance at block 804. At block 808, the apparatus causes determination of platform tolerance based, at least in part, on the reported latency tolerance, similar as described regarding FIG. 1. In at least one example embodiment, the platform latency tolerance is based, at least in part, on the reported latency tolerance such that the latency tolerance of the device associated the reported latency tolerance is not represented by the predefined latency tolerance. For example, if, at block 802, the apparatus had not received a reported latency tolerance for a specific device or set of devices, and the predetermined latency tolerance was used to represent latency tolerance of the specific device or set of devices at block 804, the determination of block 808 may exclude consideration of the predefined latency tolerance in association with the specific device or set of devices. In such an example, at block 808, the predetermined latency tolerance may be considered for one or more other devices, but the receiving of the reported latency tolerance for the specific device or set of devices may preclude consideration of the predetermined latency tolerance to represent latency tolerance for the specific device or devices.

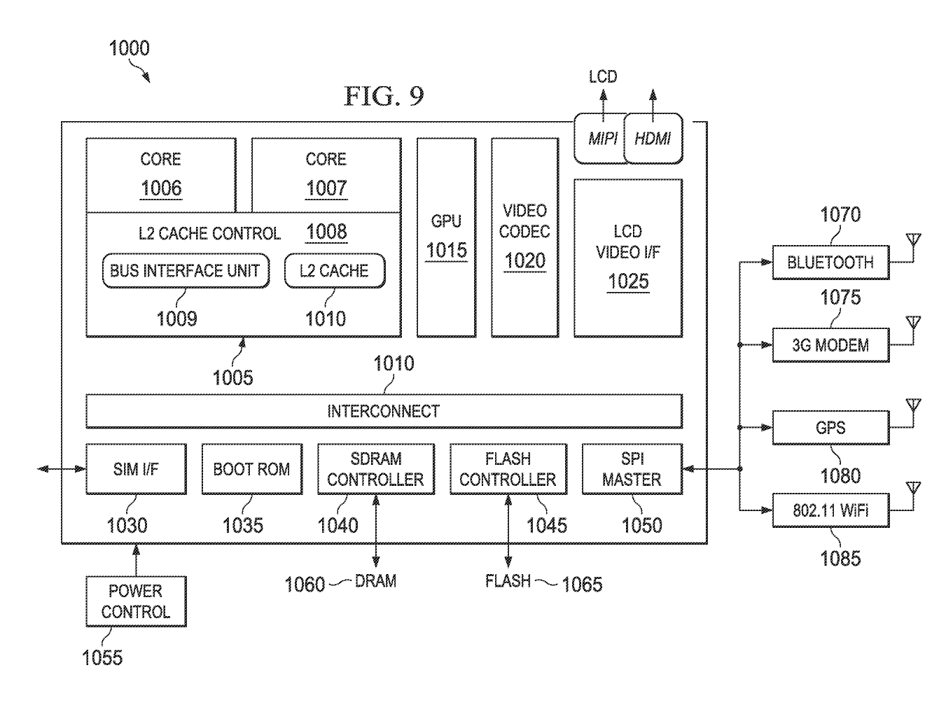

FIG. 9 is a simplified block diagram associated with an example ARM ecosystem SOC 1000 of the present disclosure. At least one example implementation of the present disclosure includes an integration of the power savings features discussed herein and an ARM component, For example, the example of FIG. 9 can be associated with any ARM core (e.g., A-9, A-15, etc.), Further, the architecture can be part of any type of tablet, smartphone (inclusive of Android™ phones, i-Phones™), i-Pad™, Google Nexus™, Microsoft Surface™, personal computer, server, video processing components, Ultrahook™ system, laptop computer inclusive of any type of notebook), any type of touch-enabled input device, etc.

In this example of FIG. 9, ARM ecosystem SOC 1000 may include multiple cores 1006-1007, an L2 cache control 1008, a bus interface unit 1009, an L2 cache 1010, a graphics processing unit (GPU) 1015, an interconnect 1010, a video codec 1020, and a liquid crystal display (LCD) I/F 1025, which may be associated with mobile industry processor interface (MIPI)/high-definition multimedia interface (HDMI) links that couple to an LDC.

ARM ecosystem SOC 1000 may also include a subscriber identity module (SIM) I/F 1030, a boot read-only memory (ROM) 1035, a synchronous dynamic random access memory (SDRAM) controller 1040, a flash controller 1045, a serial peripheral interface (SPI) master 1050, a suitable power control 1055, a dynamic RAM (DRAM) 1060, and flash 1065. In addition, one or more example embodiment include one or more communication capabilities, interfaces, and features such as instances of Bluetooth 1070, a 3G modem 1075, a global positioning system (GPS) 1080, and an 802.11 WiFi 1085.

In operation, the example of FIG. 9 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

FIG. 10 is a simplified block diagram illustrating potential electronics and logic that may be associated with any of the power saving operations discussed herein. In at least one example embodiment, system 1100 includes a touch controller 1102, one or more processors 1104, system control logic 1106 coupled to at least one of processor(s) 1104, system memory 1108 coupled to system control logic 1106, non-volatile memory and/or storage device(s) 1110 coupled to system control logic 1106, display controller 1112 coupled to system control logic 1106, display controller 1112 coupled to a display, power management controller 1118 coupled to system control logic 1106, and/or communication interfaces 1120 coupled to system control logic 1106.

System control logic 1106, in at least one embodiment, includes any suitable interface controllers to provide for any suitable interface to at least one processor 1104 and/or to any suitable device or component in communication with system control logic 1106. System control logic 1106, in at least one example embodiment, includes one or more memory controllers to provide an interface to system memory 1108, System memory 1108 may be used to load and store data and/or instructions, for example, for system 1100. System memory 1108, in at least one example embodiment, includes any suitable volatile memory, such as suitable dynamic random access memory (DRAM) for example. System control logic 1106, in at least one example embodiment, includes one or more input/output (I/O) controllers to provide an interface to a display device, touch controller 1102, and non-volatile memory and/or storage device(s) 1110.

Non-volatile memory and/or storage device(s) 1110 may be used to store data and/or instructions, for example within software 1128. Non-volatile memory and/or storage device(s) 1110 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 1118 may include power management logic 1130 configured to control various power management and/or power saving functions disclosed herein or any part thereof. In at least one example embodiment, power management controller 1118 is configured to reduce the power consumption of components or devices of system 1100 that may either be operated at reduced power or turned off when the electronic device is in the dosed configuration. For example, in at least one example embodiment, when the electronic device is in a closed configuration, power management controller 1118 performs one or more of the following: power down the unused portion of the display and/or any backlight associated therewith; allow one or more of processor(s) 1104 to go to a lower power state if less computing power is required in the closed configuration; and shutdown any devices and/or components, such as keyboard 108, that are unused when an electronic device is in the dosed configuration.

Communications interface(s) 1120 may provide an interface for system 1100 to communicate over one or more networks and/or with any other suitable device. Communications interface(s) 1120 may include any suitable hardware and/or firmware. Communications interface(s) 1120, in at least one example embodiment, may include, for example, a network adapter, a wireless network adapter, a telephone modem, and/or a wireless modem.

System control logic 1106, in at least one example embodiment, includes one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example embodiment, at least one processor 1104 may be packaged together with logic for one or more controllers of system control logic 1106. In at least one example embodiment, at least one processor 1104 may be packaged together with logic for one or more controllers of system control logic 1106 to form a System in Package (SiP). In at least one example embodiment, at least one processor 1104 may be integrated on the same die with logic for one or more controllers of system control logic 1106. For at least one example embodiment, at least one processor 1104 may be integrated on the same die with logic for one or more controllers of system control logic 1106 to form a System on Chip (SoC).

For touch control, touch controller 1102 may include touch sensor interface circuitry 1122 and touch control logic 1124. Touch sensor interface circuitry 1122 may be coupled to detect touch input over a first touch surface layer and a second touch surface layer of display 11 (i.e., display device 1110). Touch sensor interface circuitry 1122 may include any suitable circuitry that may depend, for example, at least in part on the touch-sensitive technology used for a touch input device. Touch sensor interface circuitry 1122, in one embodiment, may support any suitable multi-touch technology. Touch sensor interface circuitry 1122, in at least one embodiment, includes any suitable circuitry to convert analog signals corresponding to a first touch surface layer and a second surface layer into any suitable digital touch input data. Suitable digital touch input data for one embodiment may include, for example, touch location or coordinate data.

Touch control logic 1124 may be coupled to help control touch sensor interface circuitry 1122 in any suitable manner to detect touch input over a first touch surface layer and a second touch surface layer. Touch control logic 1124 for at least one example embodiment may also be coupled to output in any suitable manner digital touch input data corresponding to touch input detected by touch sensor interface circuitry 1122. Touch control logic 1124 may be implemented using any suitable logic, including any suitable hardware, firmware, and/or software logic (e.g., non-transitory tangible media), that may depend, for example, at least in part on the circuitry used for touch sensor interface circuitry 1122. Touch control logic 1124 for one embodiment may support any suitable multi-touch technology.

Touch control logic 1124 may be coupled to output digital touch input data to system control logic 1106 and/or at least one processor 1104 for processing. At least one processor 1104 for one embodiment may execute any suitable software to process digital touch input data output from touch control logic 1124. Suitable software may include, for example, any suitable driver software and/or any suitable application software. As illustrated in FIG. 11, system memory 1108 may store suitable software 1126 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This includes the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that includes digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that the blocks in the flow diagrams illustrate only some of the possible signaling scenarios and patterns that may be executed by, or within, the circuits discussed herein. Some of these blocks may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein. In addition, one or more blocks of one flow diagram may be combined with one or more blocks of another diagram.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

One particular example implementation may include an apparatus that includes means for determining that a first reported latency tolerance, the first reported latency tolerance representing at least one first device, has not been receive, and means for causing determination of a platform latency tolerance based, at least in part, on a first predefined latency tolerance, the predefined latency tolerance that serves as a substitute for the first reported latency tolerance

What is claimed is:

1. A method to determine latency tolerance, comprising:
determining that a reported latency tolerance associated with at least one device has not been received; and
causing determination of a platform latency tolerance based, at least in part, on a predefined latency tolerance, which is to serve as a substitute for the first reported latency tolerance.

2. The method of claim 1, wherein causing determination of the platform latency tolerance comprises determining platform latency tolerance.

3. The method of claim 1, wherein causing determination of a platform latency tolerance based, at least in part, on the predefined latency tolerance comprises sending the predefined latency tolerance in place of the reported latency tolerance.

4. The method of claim 1, wherein determining that a reported latency tolerance has not been received comprises determining that the first device did not send the reported latency tolerance.

5. The method of claim 1, further comprising determining that the at least one device is attached to a particular controller.

6. The method of claim 1, further comprising:
receiving information indicating a directive to change a value indicated by the predefined latency tolerance to a different value; and
causing determination of the platform latency tolerance based, at least in part, on the different value.

7. The method of claim 1, further comprising receiving the reported latency tolerance, and causing determination of a platform latency tolerance based, at least in part, on the reported latency tolerance.

8. The method of claim 1, wherein determining that a reported latency tolerance has not been received comprises determining that a controller did not send the reported latency tolerance, and further comprising receiving another reported latency tolerance from another controller, wherein determination of a platform latency tolerance is further based, at least in part, on the other reported latency tolerance.

9. An apparatus to determine latency tolerance comprising logic, the logic at least partially including hardware logic, to:
determine that a reported latency tolerance associated with at least one device has not been received; and
cause determination of a platform latency tolerance based, at least in part, on a predefined latency tolerance, which is to serve as a substitute for the first reported latency tolerance.

10. The apparatus of claim 9, wherein causation of determination of the platform latency tolerance comprises determination of platform latency tolerance.

11. The apparatus of claim 9, wherein causation of determination of a platform latency tolerance based, at least in part, on the first predefined latency tolerance comprises to send the predefined latency tolerance in place of the reported latency tolerance.

12. The apparatus of claim 9, wherein determination that a reported latency tolerance has not been received comprises determination that the device did not send the reported latency tolerance.

13. The apparatus of claim 9, further comprising logic, the logic at least partially including hardware logic, to determine that the at least one device is attached to a particular controller.

14. The apparatus of claim 9, further comprising logic, the logic at least partially including hardware logic, to:
receive information that indicates a directive to change a value indicated by the predefined latency tolerance to a different value; and
cause determination of the platform latency tolerance based, at least in part, on the different value.

15. The apparatus of claim 9, further comprising logic, the logic at least partially including hardware logic, to:
receive the reported latency tolerance; and
cause determination of a platform latency tolerance based, at least in part, on the reported latency tolerance.

16. The apparatus of claim 9, wherein determination that a reported latency tolerance has not been received comprises determination that a controller did not send the reported latency tolerance, and further comprising logic, the logic at least partially including hardware logic, to receive another reported latency tolerance from another controller, wherein determination of a platform latency tolerance is further based, at least in part, on the other reported latency tolerance.

17. A non-transitory computer readable medium to determine latency tolerance comprising computer instructions, that, when executed by at least one processor, cause an apparatus comprising the processor to:
determine that a reported latency tolerance associated with at least one device has not been received; and
cause determination of a platform latency tolerance based, at least in part, on a predefined latency tolerance, which is to serve as a substitute for the reported latency tolerance.

18. The computer readable medium of claim 17, wherein causing determination of the platform latency tolerance comprises determining platform latency tolerance.

19. The computer readable medium of claim 17, wherein causing determination of a platform latency tolerance based, at least in part, on the predefined latency tolerance comprises sending the predefined latency tolerance in place of the reported latency tolerance.

20. The computer readable medium of claim 17, wherein determining that a reported latency tolerance has not been received comprises determining that the device did not send the reported latency tolerance.

21. The computer readable medium of claim 17, wherein the computer readable medium further comprises computer instructions, that, when executed by at least one processor, further cause the apparatus comprising the processor to determine that the at least one device is attached to a particular controller.

22. The computer readable medium of claim 17, wherein the computer readable medium further comprises computer instructions, that, when executed by at least one processor, further cause the apparatus comprising the processor to:
receive information indicating a directive to change a value indicated by the predefined latency tolerance to a different value; and
cause determination of the platform latency tolerance based, at least in part, on the different value.

23. The computer readable medium of claim 17, wherein the computer readable medium further comprises computer instructions, that, when executed by at least one processor, further cause the apparatus comprising the processor to:
receive the reported latency tolerance; and
cause determination of a platform latency tolerance based, at least in part, on the reported latency tolerance.

24. The computer readable medium of claim 17, wherein determining that a reported latency tolerance has not been received comprises determining that a controller did not send the first reported latency tolerance, and wherein the computer readable medium further comprises computer instructions, that, when executed by at least one processor, further cause the apparatus comprising the processor to receive another reported latency tolerance from another controller, wherein determination of a platform latency tolerance is further based, at least in part, on the other reported latency tolerance.

25. A system to determine latency tolerance, comprising a power management controller and a controller, at least one of the power management controller and controller comprising logic, the logic at least partially including hardware logic, to:
determine that a reported latency tolerance associated with at least one device has not been received; and
cause determination of a platform latency tolerance based, at least in part, on a predefined latency tolerance, which is to serve as a substitute for the reported latency tolerance.

26. The system of claim 25, wherein causation of determination of the platform latency tolerance comprises determining platform latency tolerance.

27. The system of claim 26, wherein the power management controller comprises logic, the logic at least partially including hardware logic, to:
determine that the reported latency tolerance associated with at least one device has not been received; and
determine the platform latency tolerance based, at least in part, on the predefined latency tolerance, which is to serve as a substitute for the reported latency tolerance.

28. The system of claim 25, wherein causation of determination of a platform latency tolerance based, at least in part, on the predefined latency tolerance comprises to send the predefined latency tolerance in place of the reported latency tolerance.

29. The system of claim 28, wherein the controller comprises logic, the logic at least partially including hardware logic, to:
determine that a reported latency tolerance associated with at least one device has not been received; and
cause determination of a platform latency tolerance based, at least in part, on a predefined latency tolerance, such that the predefined latency tolerance is sent to the power management controller in place of the reported latency tolerance.

30. The system of claim 29, wherein the power management controller comprises logic, the logic at least partially including hardware logic, to:
receive the predefined latency tolerance; and
determine the platform latency tolerance based, at least in part on the predefined latency tolerance.
